(19) United States
(12) Patent Application Publication
(10) Pub. No.: US 2016/0139442 A1
(43) Pub. Date: May 19, 2016

(54) TOUCH LIQUID CRYSTAL DISPLAY DEVICE

(71) Applicants: XIAMEN BOE ELECTRONICS CO., LTD., Xiamen (CN); BOE TECHNOLOGY GROUP CO., LTD., Beijing (CN)

(72) Inventors: Pengbo LI, Beijing (CN); Jian ZHONG, Beijing (CN)

(73) Assignees: Xiamen Boe Electronics Co., Ltd.; Boe Technology Group Co., Ltd.

(21) Appl. No.: 14/241,630

(22) PCT Filed: Jun. 4, 2013
(86) PCT No.: PCT/CN2013/076713

§ 371 Date: Feb. 27, 2014

(30) Foreign Application Priority Data
Mar. 19, 2013 (CN) 201310088263.8

(51) Int. Cl. G02F 1/1333; G06F 3/0354; G06F 3/044; G06F 3/045; G06F 3/046; G06F 3/041

(52) U.S. Cl. CPC G02F 1/13338; G06F 3/046; G06F 3/0416; G06F 3/0412; G06F 3/044; G06F 3/045; G06F 3/03545; G02F 1/133308; G02F 2001/133334

(57) ABSTRACT

A touch liquid crystal display device includes: a backplate; a mold frame installed on the backplate; a liquid crystal panel installed on the mold frame; a bezel covering an edge of the liquid crystal panel, wherein the bezel is connected with the backplate; an optical film and a light source fixed between the backplate and the mold frame; and an electromagnetic screen disposed on the backplate.

### TECHNICAL FIELD

Embodiments of the invention relate to a touch liquid crystal display device.

### BACKGROUND

Touch liquid crystal display device is classified into a resistive type, a capacitive type and an electromagnetic type, etc. according to a touch screen it employs. The electromagnetic-type touch liquid crystal display device is widely used due to its high positioning accuracy and suitable for handwriting input.

In the conventional electromagnetic-type touch liquid crystal display device, a liquid crystal panel and a backlight are disposed in a mold frame, an electromagnetic screen is attached to the rear side of the backlight, and in this case, the mold frame may deform for bearing the weight of the liquid crystal panel and the backlight. In order to ensure the flatness of the electromagnetic screen, the mold frame needs to be thickened so as to increase the bearing capacity of the mold frame and further to reduce deformation of the mold frame. As a result, the overall thickness of the electromagnetic-type touch liquid crystal display device is increased.

### SUMMARY OF THE INVENTION

Embodiments of the invention provide a touch liquid crystal display device. The touch liquid crystal display device includes: a backplate; a mold frame installed on the backplate; a liquid crystal panel installed on the mold frame; a bezel covering an edge of the liquid crystal panel, wherein the bezel is connected with the backplate; an optical film and a light source fixed between the backplate and the mold frame; and an electromagnetic screen disposed on the backplate.

### BRIEF DESCRIPTION OF THE DRAWINGS

FIG. 1 is a structural schematic diagram illustrating a touch liquid crystal display device according to an embodiment of the invention;

FIG. 2 is a structural schematic diagram illustrating a backplate and a mold frame in the touch liquid crystal display device engaging with each other.

### DESCRIPTION OF THE EMBODIMENTS

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

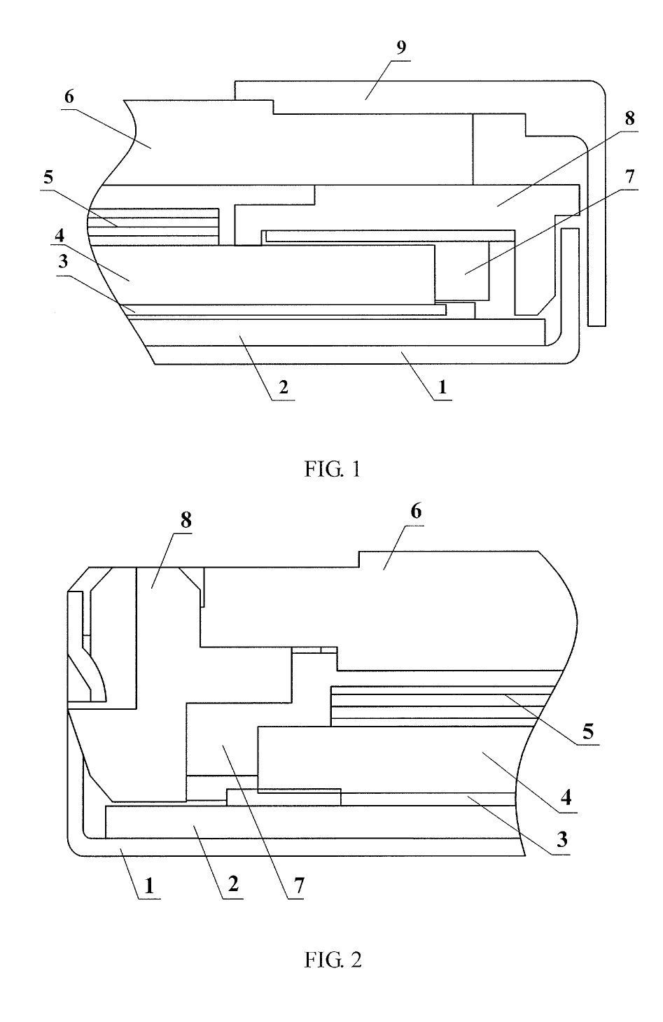

As shown in FIG. 1, an embodiment of the invention provides a touch liquid crystal display device. The touch liquid crystal display device includes: a backplate 1; a mold frame 8 installed on the backplate 1; a liquid crystal panel 6 installed on the mold frame 8; a bezel 9 covering an edge of the liquid crystal panel 6, wherein the bezel 9 is connected with the backplate 1; an optical film and a light source 7 fixed between the backplate 1 and the mold frame 8; and an electromagnetic screen 2 disposed on the backplate 1.

In FIG. 1, the light source 7 is of a side-type. However, it should be understood that the embodiment of the invention may adopt the light source 7 of direct-type as well.

If the light source 7 is of side-type, the optical film includes a reflector sheet 3, a light guide plate 4, and a film member 5. The reflector sheet 3 is disposed on the electromagnetic screen 2, and the light guide plate 4 is disposed on the reflector sheet 3. The film member 5 includes a prism film, a diffusion sheet and the like, and the film member 5 is disposed on the light guide plate 4.

If the light source 7 is of direct-type, the light source 7 is disposed on the electromagnetic screen 2. The light source 7 is generally a light bar constituted by light emitting diodes or cold cathode fluorescent lamps. In this case, the optical film is just the film member 5, which is disposed between the light source 7 and the liquid crystal panel 6.

In more detail, in the touch liquid crystal display device as shown in FIG. 1 according to the embodiment of the invention, the backplate 1 includes a flat portion and a bending portion provided on a periphery of the flat portion. For example, the backplate is made of metal, alloy, ceramic, or any other material with high strength. The backplate 1 may be obtained by punching or welding. The flat portion and the bending portion of the backplate 1 form an accommodation portion, and the electromagnetic screen 2 is provided at the bottom of the accommodation portion of the backplate 1. A backlight is provided on the electromagnetic screen 2. The backlight includes: the reflector sheet 3 provided on the electromagnetic screen 2, the light guide plate 4 provided on the reflector sheet 3, the film member 5 provided on the light guide plate 4 and the light source 7 provided on a side of the light guide plate 4. The mold frame 8 is connected with the bending portion of the backplate 1, and the liquid crystal panel 6 is provided on the mold frame 8. The bezel 9 surrounds and covers all edges of the liquid crystal panel 6 and is connected with the backplate 1. For example, the bezel 9 and the backplate 1 may be connected with each other by a screw, or by engaging with each other with a fastener and a fastener engagement portion respectively disposed on the backplate 1 and the bezel 9.

In the embodiment of the invention, the electromagnetic screen 2 is provided within the backplate 1. Compared with the mold frame 8, the material strength of the backplate 1 is high, i.e., the backplate 1 is capable of supporting the electromagnetic screen and the backlight with a less thickness. With such structure, the thickness of the mold frame 8 can be reduced, so that the thickness of the touch liquid crystal display device can be reduced.

In order to facilitate the installation and disassembly, the backplate 1 and the mold frame 8 are preferably engaged with each other. As shown in FIG. 2, the backplate 1 has the bending portion, the bending portion has a plurality of fasteners, and a plurality of fastener engagement portions with the number equal to that of the fasteners are disposed on the mold frame 8. The backplate 1 and the mold frame 8 are engaged with each other by the fasteners and the fastener engagement portions. However, the embodiment of the invention is not limited thereto, and the backplate 1 and the mold frame 8 may be connected with each other in a side lock manner, i.e., the bending portion of the backplate 1 and a side edge of the mold frame 8 are locked by a screw or a bolt.

Further, the touch liquid crystal display device may further include: an electromagnetic pen (not shown) cooperating with the electromagnetic screen 2. A magnetic field is generated on the surface of the electromagnetic screen when the electromagnetic screen is powered on, and a corresponding magnetic field is generated on the nib of the electromagnetic pen when the electromagnetic pen is input with an electrical current. When the nib of the electromagnetic pen and the electromagnetic screen approach to each other, positioning can be carried out to implement an information input with the pen. In addition, since the magnetic induction intensity is influenced by a distance, the electromagnetic pen may also implement a pressure-sensitive operation, that is, the lines drawn are of different thickness if the applied forces are different.

Further, the touch liquid crystal display device may further include: a touch screen attached on the liquid crystal panel. The touch screen may be a capacitive touch screen or a resistive touch screen, which may be selected according to the practical requirements. By providing the touch screen, the touch liquid crystal display device may achieve either the information input with the pen or the information input with the hand.

In the touch liquid crystal display device according to the embodiment of the invention, the backplate of high strength is adopted, and the electromagnetic screen and the backlight are disposed within the backplate. The mold frame merely bears the liquid crystal panel, which can reduce the load of the mold frame. Therefore, the thickness of the mold frame can be reduced, so that the thickness of the touch liquid crystal display device can be reduced.

The foregoing embodiments merely are exemplary embodiments of the invention, and not intended to define the scope of the invention, and the scope of the invention is determined by the appended claims.

1. A touch liquid crystal display device, including:
a backplate;
a mold frame installed on the backplate;
a liquid crystal panel installed on the mold frame;
a bezel covering an edge of the liquid crystal panel, wherein the bezel is connected with the backplate;
an optical film and a light source fixed between the backplate and the mold frame; and
an electromagnetic screen disposed on the backplate.

2. The touch liquid crystal display device according to claim 1, wherein the light source is of a side-type, the optical film includes a reflector sheet, a light guide plate and a film member, the reflector sheet is disposed on the electromagnetic screen, the light guide plate is disposed on the reflector sheet, the light source is disposed on a side of the light guide plate, and the film member is disposed on the light guide plate.

3. The touch liquid crystal display device according to claim 1, wherein the light source is of a direct-type, the light source is disposed on the electromagnetic screen, the optical film includes a film member, and the film member is disposed on the light source.

4. The touch liquid crystal display device according to claim 2, wherein the film member includes a prism film and a diffusion sheet.

5. The touch liquid crystal display device according to claim 1, wherein the backplate and the mold frame are engaged with each other.

6. The touch liquid crystal display device according to claim 5, wherein the backplate has a bending portion, the bending portion has a plurality of fasteners, and a plurality of fastener engagement portions with the number equal to that of the fasteners are disposed on the mold frame.

7. The touch liquid crystal display device according to claim 1, wherein the liquid crystal display device further includes an electromagnetic pen cooperating with the electromagnetic screen.

8. The touch liquid crystal display device according to claim 1, wherein the liquid crystal display device further includes a touch screen attached on the liquid crystal panel.

9. The touch liquid crystal display device according to claim 1, wherein the touch screen is a capacitive touch screen or a resistive touch screen.

10. The touch liquid crystal display device according to claim 1, wherein the backplate includes a flat portion and a bending portion provided on the periphery of the flat portion, the flat portion and the bending portion form an accommodation portion, and the electromagnetic screen is provided within the accommodation portion.

11. The touch liquid crystal display device according to claim 3, wherein the film member includes a prism film and a diffusion sheet.
